(19) United States
(12) Patent Application Publication
(10) Pub. No.: US 2003/0031812 A1
(43) Pub. Date: Feb. 13, 2003

(54) Sleeve comprising a layer for being fixed on a metal support roll

(76) Inventors: Henri Bertoncini, Bourbach le Haut (FR); Helene Biava, Sausheim (FR); Jerzy Kuczynski, Zillisheim (FR); Laurent Aubanel, Guebwiller (FR); Yves Lemble, Lauw (FR)

Correspondence Address: LADAS & PARRY, 26 WEST 61ST STREET, NEW YORK, NY, 10023, US

(21) Appl. No.: 10/148,933

(22) PCT Filed: Dec. 4, 2000
(86) PCT No.: PCT/FR00/03378

(30) Foreign Application Priority Data
Dec. 3, 1999 (FR) 99/15269

(51) Int. Cl. B32B 1/08

(52) U.S. Cl. 428/34.9; 428/36.91

(57) ABSTRACT

The invention concerns a sleeve designed to mountedon a metal support roll and comprising layer (20) forming the outer surface of the sleeve, and layer for being fixed (21) on the roll (1) whereof the constituent material is designed to be fixed to the roll metal by a physicl interface. The invention is useful for transforming lap products.

The invention concerns the field of transformation of lap products and more specifically a sleeve intended to be integral with a metal support cylinder.

Said sleeve can be used in extremely varied techniques and in particular covering, embossing, calendering, doubling, drying and printing.

The sleeves can be cylindrical or even conical.

They can be mounted by an air cushion on a specific cylinder including compressed air circuits or even by a mechanical assembling.

Most of these sleeves can only be subjected to relatively light linear loads.

In effect, the link between the cylinder and the sleeve is not sufficient to transmit large mechanical forces and, as regards extremely heavy loads, the sleeve and the cylinder could be detached from each other.

For this reason, a sleeve intended to be subjected to heavy linear loads is generally stuck onto the surface of the cylinder. The link between the sleeve, also known as the cylinder lining or covering, and the cylinder is thus permanent.

Moreover, the cylinder coverings must be embodied directly on the cylinder.

When a printer decides to replace a worn covering, he sends the cylinder back to the manufacturer. The latter removes the worn covering and produces a new covering on the cylinder.

The embodiment of a covering thus has many drawbacks.

First of all, this requires the transport of the support cylinders which increases costs and increases the period the cylinders are immobilised for their maintenance. Moreover, as the sleeve is stuck on the cylinder, it is necessary to machine the cylinder so as to fully remove the sleeve. The removal of the machined sleeve thus results in risks of damaging the support cylinder.

Furthermore, the loads which stress a cylinder in a printing or transformation machine result in a swaying of the support cylinder.

Systems for compensating this sway have already been established.

Such a compensation system consists for example of giving a bulged shape to the outer surface of the sleeve which is mounted on the cylinder. During operation and under the effect of the loads which stress the cylinder, the axial variation of the thickness of the sleeve is compensated by the sway of the cylinder.

This compensation system makes it possible to provide a constant linear load and thus a regular treatment of the printing support in the Nip, that is the nipping zone between two cylinders in a breadth direction.

However, known compensation systems have drawbacks since it is difficult to give the desired shape to the external surface of the sleeve and its embodiment is therefore a source of errors.

Moreover, in the case where the sleeve is worn, it is sometimes necessary to rectify its external surface and it is then difficult to retain the bulged shape given to its external surface, which necessitates renewed costs and stoppages of the machine.

The aim of the invention is mitigate these drawbacks by offering a sleeve intended to be mounted on a metal support cylinder without the risk of separating despite significant linear loads, said sleeve being able to be, at least partially, manufactured before being mounted on the cylinder and being able to be easily removed so as to allow another sleeve to be mounted.

The invention also concerns providing a sway compensation system for said sleeve for which its embodiment and maintenance can be easily carried out.

Thus, the invention concerns a sleeve intended to be mounted on a metal support cylinder and including at least one operational covering forming the external surface of the sleeve, as well as an integration covering on the cylinder whose constitutive material is intended to be fixed to the metal of the cylinder by a physical link.

Throughout the description, the term “operational covering” shall be understood to be a covering which is active or fulfils one of the following functions : printing, varnishing, embossing covering, drying, calendering, doubling or any other favourable function in transformation methods for cylinders comprising an operational covering of the polymeric, compound, elastomer or ceramic type.

This functional covering can be a printing covering, an anti-wear covering, for example a ceramic covering, a covering providing a certain resilience, like an elastomeric covering, or even a covering making it possible to receive ink, for example on the external surface of the sleeve and in particular especially constituted by the ceramic or metal with hollow portions.

The physical link between the sleeve and the support cylinder has some advantages. It is different to a chemical link, for example obtained by means of a permanent adhesive, since it makes it possible to remove the sleeve from the cylinder without having to machine the metal cylinder. However, it provides the same resistance upon separation as that provided by a chemical link.

In a first embodiment, the sleeve comprises an integration covering made of a compressible material, the sleeve being intended to be forcefully fixed on the support cylinder.

In a second embodiment, the integration covering is made of an expansible material, said material being intended to be expanded after the sleeve is mounted on the support cylinder.

The expansible material is then advantageously compressible after expansion.

The integration covering also advantageously comprises a heat-retractable material which, during expansion of the integration covering under the effect of heat, causes the tightening of the sleeve on the cylinder.

In a third embodiment, the integration covering is constituted by a hardenable material which is hardened after it has been introduced between the cylinder and sleeve mounted with play on the cylinder.

The sleeve of the invention can also include at least one support so as to strengthen the rigidity of the sleeve.

The support covering is able to also mechanically protect the integration covering and modulate the mechanical behaviour of said sleeve.

The sleeve of the invention advantageously includes a system for compensating the sway of the support cylinder on which it is to be mounted.

In a first embodiment, this compensation system includes a compressible covering whose compressibility is variable along the axis of the sleeve.

The module of elasticity of this covering can vary in an axial direction.

The thickness of this covering can also vary in an axial direction.

In this case, this variable compressibility covering can have a single parabolic, multiple parabolic, staged or even truncated profile.

In one embodiment variant of the sleeve, this variable compressibility covering is the integration covering of the sleeve on the support cylinder.

In this case, the sleeve can be fixed on a support cylinder having a variable thickness.

In another embodiment variant, this variable compressibility covering is situated between two coverings of the sleeve.

In another embodiment variant of the sway compensation system, the sleeve comprises at least one chamber between two of its coverings, this chamber containing a pressurised fluid.

The invention also concerns a method for mounting a sleeve on a metal support cylinder, said sleeve comprising at least one functional covering forming the outer surface of the sleeve, the method consisting of:

mounting said sleeve with play on the support cylinder,

introducing an expansible material under a given stress, this material being positioned between the support cylinder and the sleeve after the latter has been mounted, and

applying said stress so as to provoke expansion of the expansible material and the sleeve being rendered integral on the cylinder by means of a physical or chemical link.

In a particular embodiment of the method, the expansible material is deposited, before the sleeve is mounted on the support cylinder, on the external surface of the support cylinder or on the internal surface of the sleeve.

The expansible material preferably appears in the form of a strip deposited by being wound on the cylinder or even in the form of a tube.

Said strip or tube advantageously comprises at least one self-adhesive covering one of the faces so as to enable it to be fixed on the cylinder or the sleeve.

The invention also concerns another method for mounting a sleeve on a metal, said sleeve comprising at least one functional covering forming the external surface of the sleeve, the method consisting of:

mounting the sleeve with play on the support cylinder,

placing a hardenable material, especially by means of injection or pouring, between the sleeve and the support cylinder, and

provoking hardening of the material and thus integration of said sleeve on the support cylinder by means of a physical or chemical link.

The invention further concerns a unit for a printing or transformation machine including a metal support cylinder on which fixed is a sleeve comprising at least one functional covering forming the external surface of the sleeve and an integration covering physically linked to the metal of the cylinder.

Said integration covering can advantageously be made of a compressible, expanded or hardened material.

Preferably, this unit includes a system for compensating the sway of the cylinder.

In a first embodiment, said unit comprises a sleeve with a compressible covering whose compressibility is variable along the axis of said unit.

The modulus of elasticity of this compressible covering may vary in an axial direction, the thickness of said covering also being able to vary in the same axial direction.

In one embodiment variant, said variable compressibility covering is the integration covering of the sleeve on the support cylinder.

In this case, the support cylinder can have a variable thickness.

In another embodiment variant, this variable compressibility covering is situated between two coverings making up the sleeve.

Finally, in another embodiment of a unit including a cylinder sway compensation system, said system is formed of a chamber situated between two coverings making up the sleeve and containing a pressurised fluid.

The invention shall be more readily understood and its other aims, advantages and characteristics shall appear more clearly on reading the following description which is given with reference to the accompanying drawings which show non-restrictive embodiments of the invention and on which:

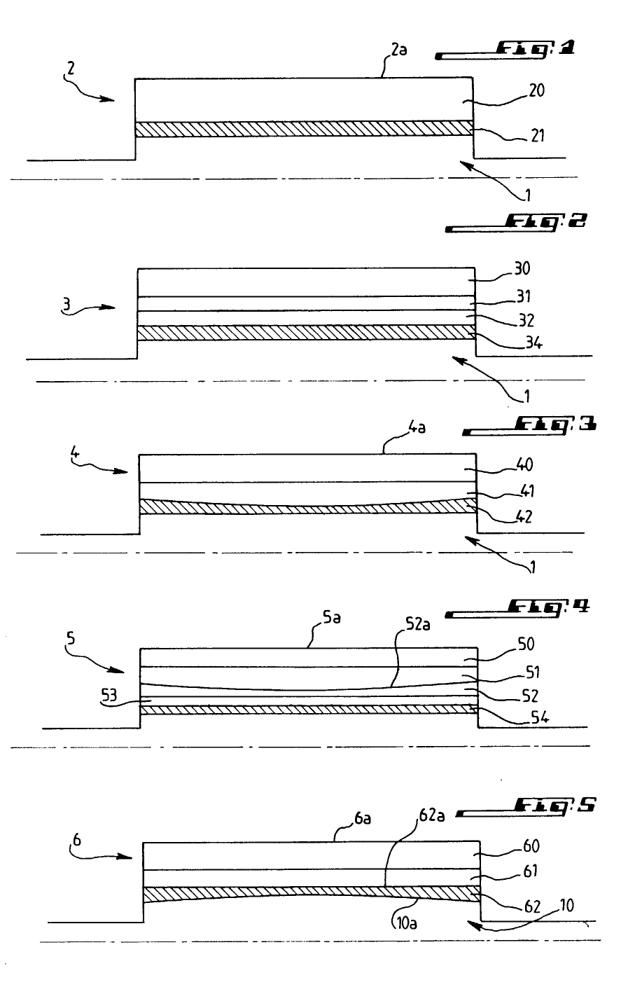

FIG. 1 is an axial sectional half-view of a printing or transformation unit according to the invention including a support cylinder and a sleeve.

FIG. 2 is an axial sectional half-view of a variant of a printing or a transformation unit shown on FIG. 1,

FIG. 3 is an axial sectional half-view of a first example of a printing or transformation unit according to the invention and comprising a system for compensating the sway of the cylinder,

FIG. 4 is an axial sectional half-view showing a variant of the printing or transformation unit shown on FIG. 3, and

FIG. 5 is also an axial sectional half-view of another embodiment variant of the printing or transformation unit shown on FIG. 3.

Reference is now first of all made to FIG. 1 which shows a printing or transformation unit including a metal support cylinder 1 on which a sleeve 2 is fixed.

In the embodiment example shown on FIG. 1, this sleeve 2 includes a functional covering 20 forming the outer surface 2a of the sleeve and an integration covering 21 which is secured to the cylinder 1 by means of a physical or chemical link.

The thickness of the functional covering is normally between 8 and 25 mm, the thickness of the integration covering being normally between 0.5 and 10 mm.

The printing unit shown on FIG. 1 can be obtained via various ways.

First of all, the sleeve is embodied independently, and then forcibly mounted on the metal cylinder 1 by known means in the prior art.

In this case, the integration covering 21 is preferably compressible. It can also comprise a surface relief on its internal face, which makes it easy to fix the sleeve on the cylinder.

The integration covering 21 can also be embodied at least partially, after the sleeve 2 has been mounted on the cylinder 1, a play is provided between the sleeve and the cylinder.

It is first possible to deposit an expansible material on the internal face of the operational covering 20 or on the external surface of the cylinder 1.

In a first variant, this expansible material can take the form of strip, strip-rolled on the cylinder 1.

The functional covering 20 is then mounted, with a play on the cylinder strip-rolled with said strip, which is preferably provided with an auto-adhesive covering so as facilitate its positioning on the cylinder 1.

Once the functional covering is placed around the cylinder, expansion of the strip-rolled strip is provoked particularly by the action of the heat if the material is expansible under the effect of the heat.

To do this, the unit is placed in an oven or heated by infrared means or microwaves or even by induction.

During expansion of the strip, annexed devices are used to keep the cylinder 1 and the functional covering 20 concentric.

In a variant, this expansible material can be secured to the internal face of the functional covering, the integration between the functional covering and the cylinder being effected as described previously.

Moreover, this strip can be replaced by a preformed tube made of an expansible material and positioned on the cylinder 1 or on the internal face of the functional covering 20 before it is mounted around the cylinder 1.

Thus, it is this expansion of the expansible material previously provided under the functional covering 20 or on the support cylinder 1 which creates integration between the functional covering 20 and the cylinder 1.

It is also possible to provide that the expansible material comprises a heat-retractable material, such as a heat-retractable fabric which during expansion under the effect of the heat also provokes at the same time tightening of the functional covering 20 on the support cylinder 1.

In another embodiment variant, the integration covering made of an expansible material can be obtained by pouring or injecting an expansible material between the functional covering 20 and the support cylinder 1 after mounting with play of the functional covering 20 on the support cylinder 1.

Means able to ensure the concentricity of the sleeve and the support cylinder can be advantageously used.

Here again, integration between the functional covering 20 and the support cylinder 1 is obtained at the time of expansion of the expansible material placed between the functional covering and the support cylinder.

Again it may be noted that the expansible material used to form the integration covering can fulfil an additional sealing function so as to protect the outer surface of the metal support cylinder against corrosion.

Finally, the integration covering 21 can be obtained by injecting or pouting a hardenable material between the functional covering 20 and the support cylinder 1 after mounting the functional covering on the support cylinder.

Integration between the functional covering 20 and the support cylinder 1 is obtained by hardening of this material, especially by means of thickening or cross linking.

Annexed devices are also used in this case so as to ensure concentricity between the support cylinder and the sleeve.

The diameter of the support cylinder/sleeve unit obtained is approximately between 60 and 500 mm, whereas its length may range up to 7 m.

The thickness of the integration covering is typically between 0.5 and 10 mm.

In the case where the integration covering is obtained from an expansible or hardenable material, the production tolerances of the cylinder 12 and of the functional covering 20 are not extremely severe since the integration covering can compensate certain defects to the extent where the concentricity between the support cylinder and the sleeves is fully ensured.

In the preceding description, it has been considered that the sleeve was solely made up of a functional covering 20 and an integration covering 21.

Of course, the invention is not merely limited to this embodiment and the sleeve could comprise other coverings, especially one or several support coverings, other functional coverings or even coverings not fulfilling any particular function during printing but making it possible to adjust the diameter of the sleeve.

In this respect, it is possible to refer to FIG. 2 which illustrates a support cylinder 1 to which a sleeve 3 is secured including a functional covering 30 forming the outer surface of the sleeve, a reinforcement covering 31, another functional covering 32 which here is a compressible covering and an integration covering 34.

This covering 34 shall not be described in detail since it can be embodied like the covering 21 described with reference to FIG. 1.

The support covering 31 can in particular be made of a composite material obtained with a lap of glass fibres impregnated with resin. Fibres other than glass fibres can be used with any known type of resin for this type of application.

The support covering can also be made of a hard and thick material so as to compensate with a fixed total thickness a reduced thickness of the functional covering with the aim of hardening the Nip.

There now follow two examples illustrating the method for mounting a sleeve according to the invention.

In these two examples, the integration covering of the sleeve is obtained via the expansion of an expansible material and the sleeve includes a functional covering, a support covering and an integration covering (embodiment example not shown on FIGS. 1 and 2).

### EXAMPLE 1

The sleeve made of a glass-epoxy composite support 2 mm thick and an elastomer covering with a hardness of 95 Shore A (CSM family) and a thickness of 15 mm is produced on a mandrel with a diameter of 74.4 mm and machine width of 1000 mm.

The internal surface of the sleeve shows a slight relief so as to facilitate the mechanical hooking with the integration covering described hereafter.

A strip of a thermoplastic mixture from the family of polyolefines having a hardness of 75 ShA and containing 5% of an inflating agent (temperature-expansible microsphere of the Expancell brand) is extruded separately in the form of a strip with a thickness of 1 mm. Extrusion is made at a temperature so that the microspheres do not expand during extrusion.

The strip described above is wound helically onto a metal core (support cylinder) with a diameter of 68 mm and edge to edge with a single covering.

The metal core has an external surface which is machined or unpolished.

The sleeve described above is fitted on the unit constituted by the metal core, diameter 68 mm, with its strip. As the internal diameter of the sleeve is greater by 3.2 mm than that of the metal core, this operation is eased as a consequent play remains.

The unit is mechanically blocked on the edges and heated inside an oven. The cycle has been 2 hrs at 80° C. followed by 2 hrs at 120° C. The expansion of the strip fills the space between the metal core and the sleeve and creates a mechanical tightening stress.

After cooling, the unit is machined concentrically and cylindrically before being subjected to an endurance test.

The linear load supported continuously by the sleeve integrated at a linear speed of 50 m/min has been 49 N/mm. The result obtained is sufficient for a sleeve of the tested size with a functional coating having a hardness of 85 ShA.

Known simple means are available to increase the admissible load if this is necessary:

higher containment of the integration covering with weaker expansion;

reduction of thickness of the integration covering;

increase of the hardness of the matrix of the integration covering (75 ShA used in the example described here up to 96 ShA).

### EXAMPLE 2

The sleeve constituted by a support covering and an elastomer covering is obtained as described in example 1.

The strip wound on the metal core is a woven heat-retractable strip impregnated with a pourable and cross-linkable polyurethane with a hardness of 75 ShA and containing 8% of an inflating agent. As pouring is made at ambient temperature, the microspheres do not expand at this stage. This strip has a nature enabling it to expand during a post-baking at 120° C.

The other stages of the mounting method are identical to those described for example 1.

Regardless of the type of integration covering and its embodiment, its main characteristic is such that it makes it possible to embody a physical link between the sleeve and the metal support cylinder.

It is appropriate not to exclude a chemical linking complement, in particular between the integration covering and the functional covering or the support cylinder if it is present.

A support cylinder equipped with a sleeve according to the invention can support linear loads of up to 350 N/mm and linear operating speeds of up to 2000 metres/min without any risk of separation between the cylinder and the sleeve.

The sleeve of the invention is thus able to combine the advantages of a covering which cannot be separated from the support cylinder, even under heavy loads, and those linked to the presence of a compressible covering.

Furthermore, when the sleeve is worn, it is easy to remove the support cylinder since it can be detached under the effect of an appropriate force.

This considerably simplifies the removal of the sleeve with respect to known coverings of the prior art which are stuck onto the support cylinder, an irreversible link thus being embodied between the covering and the support cylinder.

In particular, it suffices to clean and possibly degrease the outer surface of the cylinder 1 after fully removing the sleeve and it is not necessary to machine the outer surface of the cylinder so as to fully remove the sleeve.

This therefore eliminates the drawbacks mentioned earlier since the risks of damaging the support cylinder are eliminated. Secondly, the cylinders no longer need to be sent to the manufacturer so as to replace the sleeve. The removal of the worn sleeve and the fixing of a new sleeve can be directly effected at the premises of the printer. Thus, this considerably reduces the period and costs of maintenance of these cylinders.

This also makes it possible to reduce the number of support cylinders held by the user so as to ensure the functioning of these machines, despite the required maintenance. The printers or users are thus able to reduce their investments. Users can also reduce the production losses associated with long changes.

It is also possible to note that, when the integration covering is obtained from a hardenable or compressible material, its thickness can be modulated for a sleeve moreover comprising the same constitutive coverings. This therefore makes it possible to line support cylinders having different external diameters with a given sleeve by varying the thickness of the integration covering.

These sleeves can normally be adapted to cylinders whose diameter can vary between 1 and 10 mm.

It is also appropriate to note that the sleeves can, at least partly, be embodied before being mounted on the support cylinder. This makes it possible to reduce the period of maintenance since only the integration covering needs, if appropriate, to be produced after mounting of the sleeve on the cylinder.

Reference is now made to FIGS. 3 to 5 which illustrate a unit according to the invention and comprising a system for compensating the sway of the cylinder.

With reference first of all to FIG. 3, the printing unit of the invention comprises the cylindrical-shaped support cylinder 1 with a constant diameter and a sleeve 4 secured to the cylinder.

This sleeve 4 comprises a functional covering 40 forming the outer surface 4a of the sleeve, an intermediate covering 41, especially a support covering such as the covering 31 described with reference to FIG. 2, and an integration covering 42.

This integration covering 42 can in particular be made of an expanded or again hardened material, like the coverings 21 and 34 which have been previously described with reference to FIGS. 1 and 2.

This integration covering 42 here has a parabolic profile. This profile could also be conical or staged conical. This profile is obtained by giving the internal surface of the covering 41 a complementary shape bulged towards the axis of the sleeve.

After mounting of the sleeve initially constituted by the coverings 40 and 41 around the support cylinder 1, the hardenable or expansible material placed between the internal surface of the covering 41 and the outer surface of the support cylinder 1 is expanded or hardened, as described previously with reference to FIG. 1.

This expanded or hardened material thus fills the space between the sleeve and the cylinder which ensures fixing of the sleeve on the support cylinder with an integration covering having this parabolic profile making it possible to compensate the sway of the cylinder during its use in a printing machine.

It has been noted that with this compensation system, the outer surface of the sleeve is cylindrical and has a constant thickness. Thus, compensation of the sway is obtained for a given load without having to give a particular shape to the outer surface of the sleeve, which eliminates the drawbacks of currently known compensation systems.

Furthermore, when the compensation system is formed by the integration covering, it is obtained extremely easily by rendering the sleeve integral on the support cylinder.

In this case, the compensation of the sway is clearly obtained first of all by the variation of the thickness of the integration covering along the axis of the support cylinder 1. In addition, the variable thickness between the internal surface of the covering 41 and the outer surface of the cylinder 1 generates during forming of the integration covering 42 a variation of the compression module in the covering 42.

Generally speaking, the variation profile of the thickness of the covering 42 is selected so as to obtain a suitable compensation of the sway of the cylinder for given dimensions of the cylinder and a given operating linear load.

FIG. 4 shows another embodiment of the compensation system.

The reference 1 again denotes a support cylinder with a constant diameter along the axis of the cylinder.

The sleeve 5 of the invention comprises a functional covering 50 forming the outer surface 5a of the cylinder/sleeve unit, a support covering 51, a covering 52 allowing compensation of the sway of the cylinder, another support covering 53 and an integration covering 54.

The integration covering 54 is obtained as described previously for the coverings 21 of the sleeve 2 and 34 of the sleeve 3.

On its outer face 52a, the covering 52 has a parabolic profile, the inner surface of the covering 51 having a complementary shape. The profile could also be conical.

This covering 52 thus has a variable thickness along the axis of the cylinder 1 and, if appropriate, a module of elasticity, also variable along the axis of the sleeve 5.

This module variation and/or thickness variation makes it possible to compensate the sway of the cylinder whilst retaining a sleeve with a constant diameter.

Finally, reference is made to FIG. 5 which shows another embodiment of a support cylinder/sleeve unit according to the invention with a sway compensation system.

Thus unit is constituted by a support cylinder 10 and a sleeve 6.

The cylinder 10 comprises a bulged outer surface 10a with a parabolic profile. This profile could also be conical. The sleeve 6 comprises a functional covering 60 forming the outer surface 6a of the unit, a support covering 61 and an integration covering 62.

This integration covering 62 is obtained from a hardenable or expansible material, like the coverings 21 and 34 shown on FIGS. 1 and 2.

The coverings 60 and 61 have a constant thickness. The integration covering 62 has on its outer surface 62a a cylindrical shape and on its internal face a conical profile complementary to the conical profile of the outer surface 10a of the support cylinder 10.

By means of the special profile of the support cylinder 10, here again a system is obtained for compensating the sway of the cylinder by virtue of a variation of the thickness of the integration covering in an axial direction and possibly a variation of the elasticity module in this same axial direction.

Of course, the invention is not merely limited to the embodiments described above and in particular the covering of the sleeve used to compensate the sway of the cylinder could have only one module of elasticity able to vary in an axial direction by having a constant thickness.

Moreover, the embodiments described in reference to firstly FIGS. 3 and 4 and secondly 5 could be combined. Thus, the sleeve could comprise an integration covering of variable thickness by virtue of a support cylinder of variable diameter and also another covering inside the sleeve comprising a special profile, like the covering 52 described with reference to FIG. 4.

It is also possible to provide a profiled cylinder and a support covering, also profiled, as shown on FIG. 3, the profile of the cylinder and that of the support covering being adapted so as to give the integration covering a desired thickness variation.

During operation, the compressible covering 42, 52 or 62 is warped on compression under the effect of loads in the nip. This compressible covering is warped more at the extremities of the sleeve than at its centre, which compensates the sway of the cylinder by generating a uniform linear load.

The unit of the invention could also include a sway compensation system constituted by a chamber placed inside the sleeve and containing a pressurised fluid and having an adapted geometry.

Generally speaking, the units of the invention are able to compensate sways of up to 4 mm.

The main advantage of the compensation system provided in the sleeve of the invention is to render irrelevant the bulged profile given to known sleeves in the prior art so as to obtain this sway compensation. This advantage thus constitutes a considerable simplification of the production of the sleeve and thus reduces costs. Moreover, the sleeves are generally rectified on several restarts so as to regenerate the work surface. These successive rectifications can lead to errors concerning the definition of the outer surface of the sleeve which in turn leads to inappropriate sway compensations. This drawback is completely avoided with the invention as it merely suffices that the diameter of the sleeve is constant.

The incorporation of a compressible or merely expanded covering also makes it possible, if required, to simply compensate the possibilities of local excess loads at the width edge of the product passing into the Nip or to protect the functional covering against accidental excess loads. This covering sort of acts as a mechanical fuse which mechanically protects the machine on which the cylinder is mounted should a foreign body happen to enter the Nip.

It is also possible to note that the presence of an integration covering and, if applicable, a polymer compressible covering, which can be rendered damping by known means, contributes in damping the vibrations or the dynamic response in cases of impacts of the assembly constituted by the cylinder and the sleeve. The effectiveness of the damping polymer covering is also increased by the containment of the latter between the rigid coverings constituted respectively by the cylinder and a support covering.

The aim of the reference signs inserted following the technical characteristics featured in the claims is to simplify understanding of the latter and would not limit their extent.

1. Sleeve to be mounted on a metal support cylinder and including at least one functional covering (20, 30, 40, 50) forming the outer surface of the sleeve, as well as an integration covering (21, 34, 42, 54) of the cylinder whose basic material is intended to be fixed to the metal of the cylinder by a physical link, characterized in that the integration covering is made of an expansible material whose expansion can be selectively triggered after mounting the sleeve with play on the support cylinder, this material being after mounting in the non-expanded state in the space between the covering and the support cylinder.

2. Sleeve according to claim 1, in which the expansible material is compressible after expansion.

3. Sleeve according to claim 1 or 2, in which the integration covering also includes a heat-retractable material which, during expansion of the integration covering under the effect of heat, provokes tightening of the sleeve on the cylinder.

4. Sleeve according to one of claims 1 to 3, comprising at least one support covering (31, 41, 51, 53).

5. Sleeve according to one of claims 1 to 4, including a system for compensating the sway of the support cylinder.

6. Sleeve according to claim 5, including a compressible covering (42, 52, 62) whose compressibility is variable along the axis of the sleeve.

7. Sleeve according to claim 6, in which the modulus of elasticity of this compressible covering varies in the axial direction.

8. Sleeve according to claim 6 or 7, in which the thickness of this compressible covering (42, 52, 62) varies in the axial direction.

9. Sleeve according to claim 8, in which this compressible covering has a single parabolic, multiple parabolic, tiered or even truncated profile.
